(19) United States
(12) Patent Application Publication
(10) Pub. No.: US 2005/0218210 A1
(43) Pub. Date: Oct. 6, 2005

(54) System and method for providing personal identification or recognition pieces to a small group or family of participants

(76) Inventor: Dan J. Schroer, Wapakoneta, OH (US)

Correspondence Address: WARD KRAFT, INC., P.O. BOX 938, FORT SCOTT, KS, 66701, US

(21) Appl. No.: 10/813,932

(22) Filed: Mar. 31, 2004

(51) Int. Cl. G06K 5/00

(52) U.S. Cl. 235/380

(57) ABSTRACT

The present invention relates to a personal identification method and system that enables families or small groups to efficiently provide recognition or identification pieces to members of the group or family to enable participation in an activity or event. The system includes a package having supply of business forms having one or more removable or detachable wristbands, software for creating the personalized wristbands and related marketing collateral and possibly promotional pieces.

### CROSS-REFERENCES TO RELATED APPLICATIONS

None.

### FIELD OF THE INVENTION

The present invention is directed to the field of methods and systems that are usable to provide personal identification or recognition pieces. More particularly the automated system and method pertains to the ability to record and produce personal identification pieces for members of a predetermined group or predefined unit such as a family unit. The system of the present invention includes a number of prepackaged articles, such as business forms with removable or detachable identification bands and readable software that enables the ready rendering of personal identification bands, such as wrist bands. The intent of the invention is to provide users having responsibility for a limited population or group with the ability to quickly and accurately provide recognition elements so that a participant may be easily confirmed as belonging to the specific population, subset or group.

### BACKGROUND OF THE INVENTION

Societal changes have regrettably required an increase in the need for identifying, labeling, branding and providing recognition devices particularly to children so as provide greater security for the children; to aid in their identification and provide assistance in the possible recovery of a child after abduction.

Various identification bracelets, cards, tags etc. have heretofore been utilized in providing identification and recognition pieces for use in labeling children. Such products are offered for example by IDENT-A-KID® of St. Petersburg, Fla. This product requires the establishment of a temporary location at which photographs can be taken, as well as other information relating to the child captured. An identification card is then prepared with the child's image and details, much in the same way as one would obtain an adult driver's license of the like. While such systems are generally invaluable for use with the identification of large groups or in special sponsored events (e.g. local police department initiatives, etc.), unfortunately, they do not lend themselves to family applications or other small or immediate need situations as there is no time to set up or send away for the identification materials.

There are also a number of point of use products that are available for small groups and families. These may consist of generally cellulosic based materials such as tags, labels and the like. These have been provided when entrance tickets are purchased or obtained and the purchaser is presented with a number of labels that are then filled out by each of the participants. The tags are then typically adhered to clothing or otherwise affixed to clothing or an accessory of the participant. Unfortunately, such ready made products can become easily disconnected from the participant thereby defeating the purpose of the labeling or they may be just lost, such as by breakage, during the day's activities. In addition, with status conscious pre-adolescents or teens, the label may be simply discarded either before use or slightly after use as they do not want to be seen wearing something that may not be becoming of their current attire, status in life or they may simply not wish to be identified as being connected or associated with other family members or groups.

The foregoing unfortunately presents the leader of the group, parent or guardian of the family with a number of dilemmas in that the group participants or family members are not presented with adequate identification prior to entering into an event, participating in a vacation activity or the like or alternatively, the identification piece does not remain with the participant. In addition, the group leader, parent or guardian must endure the rush typically associated with the beginning of such an activity which may not present the group leader, parent or guardian with ample opportunity to present such recognition devices or identification pieces to each of the participants.

What is needed therefore is a system and accompanying method that overcomes the drawbacks associated with the prior art products. A easily usable and deliverable system is needed that provides the group leader, parent or guardian with an efficient, simple and reliable manner in which to provide each family participant or group member with a suitable recognition device that connects the participant with the group or family, in the event that such member or participant becomes separated from the party during the activity.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to a system and method for providing a personal identification package that is intended to be used by small groups or families. The package of the present invention enables the group leader, parent or guardian to efficiently, simply and quickly render any number of identification or recognition pieces (the number of pieces corresponding to the number of members in the group or family). The system of the present invention is adapted and configured to be used in the small home office or with a personal computer system and provides the user with a number of easy to follow instructions, both in machine readable and human readable formats so that the user can complete the labeling or identification of the participants of an activity and distribute secure identification bands to each member.

As used herein the term “activity” includes commercial enterprises such as amusement parks, athletic or theatrical events, artistic presentations, as well as personal and semi public outings or gatherings such as picnics, competitions, meetings, retreats and the other events in which small groups or families may be assembled to participate or engage in a specific exercise or undertaking.

The term “recognition elements” as used herein includes wristbands, bracelets, necklaces and such other devices as may be attached or connected to an appendage, such as an arm, wrist, leg, ankle or neck and are used to identify the individual to which the element has been attached.

In one exemplary embodiment, a personal system for providing recognition elements to a small group or family is described and includes a package of printable identification bands, each of which, when removed from the business form or supporting carrier, are sized and configured to fit around an appendage. Computer readable software is also provided in the package to enable the rendering of information to at least one of the bands contained within the package, once the band and accompanying form has been removed from the package and positioned in a printer. A computer means, such as a personal computer is used for reading the readable software and an input means, such as a keyboard is provided for the purposes of inputting information into the computer means based on inquiries received from the software. The connection may be through a local area network or LAN, a global communications network, such as the Internet or other suitable means to enable the connection means to connect the computer means to a printer so that the two items may communicate with one another. The system of the present embodiment is also provided with a printer for imaging indicia on at lease one of the bands.

In a still further exemplary embodiment of the present invention a personal identification package for a group or family is provided and includes a group of at least partially blank wristbands. The wristbands may be provided on a sheet either individually or as part of a group. The package of this embodiment also includes a set of computer readable instructions for producing data on at least one of the partially blank wristbands, as well as a set of human readable instructions for using the computer readable instructions and the wristbands. A container is provided for conveniently packaging the partially blank wristbands, the computer readable instructions and the human readable instructions.

In a yet still further embodiment of the present invention a method of using a personal identification system for a small group or family is described and includes the steps of initially providing a series of at least partially blank wristbands, such as in a package of a predetermined size. Then, installing computer readable software on a computer, such as a personal computer. The software contains instructions that relate to the use of the wristbands and the operation of the system. Next, information is input into a first data field in response to queries received from the software for a first participant in a group or family activity. Then, the user determines whether additional participants are available for the group or family activity. The user then selects whether to print the first data field onto at least a first wristband or to continue with the inputting of data relating to additional participants in the activity. Finally, the information from at least the first data set is printed on the first wristband.

In a still further embodiment of the present invention a method of marketing a personal identification package to small groups and families is described and includes the steps of initially producing a package. The package of this embodiment contains at least one imprintable identification band as well as computer readable software that is intended to be loaded on a computer. Next, marketing collateral is created that is targeted at small groups or families and finally, the package is distributed in response to requests from small groups or families.

The data that is input into such exemplary systems as described above typically will include both personalized and static or fixed information. Personalized information may include such things as names, addresses, phone numbers, physical descriptions, contact details and the other information that is generally necessary to identify a participant in a particular activity.

Static or fixed information includes information that typically remains the same in those examples where more than one identification or recognition element is created such as for multiple family members and includes dates, times, locations of the activities, surnames, common numbers and contact details and the like.

Collateral materials may also be provided in connection with the marketing and packaging of the system of the present invention. Such collateral materials can relate directly to the contents of the package or system of the invention or its use, or the collateral material may be unrelated information that may be of use or value to the users of the system or package. For example, unrelated materials may include promotional offers for vacations, resort stays, discounts on attractions, meals and transportation, or may be directed to products used in the home or office such as ink or toner cartridges, stationery and office supplies and the like.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a schematic of the system used in carrying out the method of the present invention;

FIG. 2 shows the package for delivering the components usable in the system and method of the present invention;

FIG. 3 provides a block diagram illustrating and exemplary method of use of the present invention;

FIG. 3A presents a continuation of the block diagram of the exemplary method illustrated in FIG. 3;

FIG. 4 depicts a block diagram showing the method of marketing the system of the present invention;

FIG. 5 presents an exemplary configuration of a wristband that is used in the present invention; and

FIG. 6 provides an illustrative use of a wristband created through the system and using the exemplary method of the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The system and method of the present invention is designed to be implemented by small groups or families and is intended to facilitate the provision of recognition elements to each member of the group or family. The system and method is used to provide an efficient means by which a group leader, parent or guardian can gain some comfort in having the group or family attend an activity and that if one of the attendees are lost or abducted, the member can ideally be repatriated with the group.

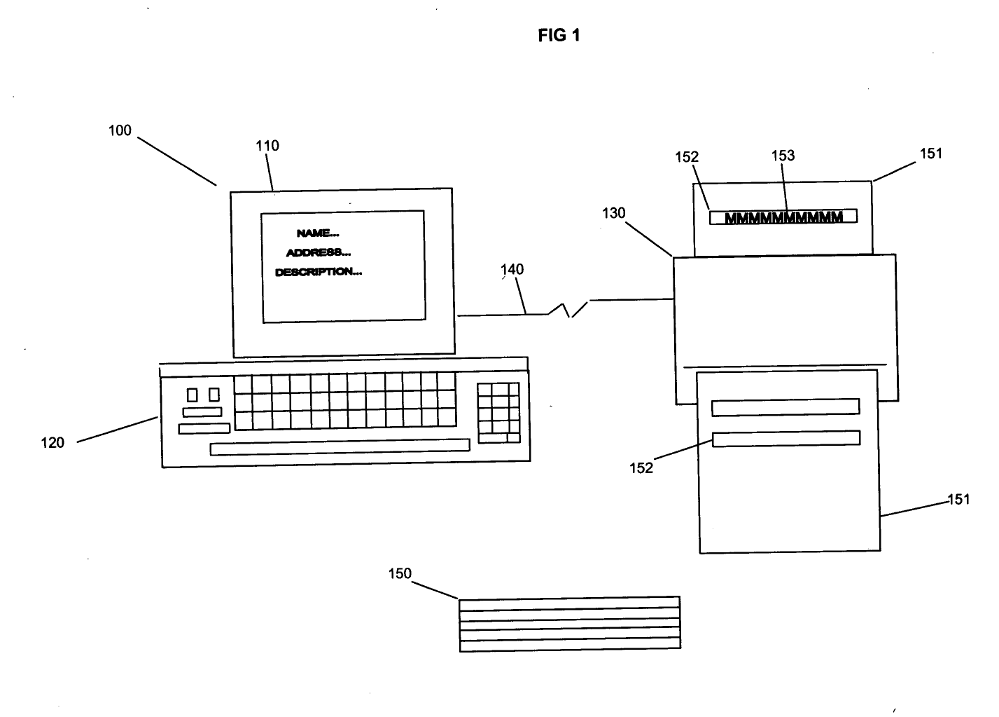

Turning to FIG. 1, a schematic of the system is presented and includes a computer means 100, such as a personal computer, laptop or the like. A computer means of the present invention may also include a personal data assistant, commonly referred to as a “PDA” such as is available from PalmSource of Sunnyvale, California. The computer means 100 generally will have a display 110 such as monitor and a means to input data 120 into the computer means 100. If the computer means 100 were a PDA, the input means may be a stylus.

As shown, the computer means 100 has initially presented the user or system operator with a number of queries, such as name, address, description which are shown on the display 110. Subsequent displays will be provided once or after the user has input all the requested or at least all of the required fields. For example, the next set of fields to be completed may relate to a personal description of the participant, such as height, weight, eye and hair color, gender and the like. Further fields may ask for information relating to contact details, group origin, hotel name, etc.

The computer means 100 is connected to a printer 130 by a communication means 140. The communication means can be a local area network (LAN), wide area network (WAN), global communications network, or any other suitable means such as interconnection cables by which a computer 100 is connected to a printer 130 or other rendering means. An exemplary printer suitable for use in carrying out the present invention may be an inkjet or laser printer available from a number of sources, such as Hewlett Packard of Palo Alto, Calif.

FIG. 1 further shows a package or stack 150 of business forms 151 that contain one or more wristbands 152. Each form 151 is positioned for insertion into the printer 130 so that the information that is input into the computer means 100 can be rendered onto each of the forms 151 and wristbands 152 that are generated. Once the form with the wristband is processed through the printer 130, the wristband is imprinted with information 153 that was input into the computer means 100. The software will normally provided formatting so that the wristband will be printed when the form is fed through the printer. Generally, the business forms or carrier forms for the wristbands will have a size of about 8½″ by 11″ but other dimensions are also possible such as 8½″ by 14″ etc.

The information that is input into the computer as well as rendered on the business form containing the wristband may be static or fixed information that is repeated on each form or band that is created or may be preconfigured based on the source of the package, such as one being sponsored by an attraction. Alternatively, all of the information applied to the forms and wristband may be unique or distinct to each band, that is the information is personalized, or combinations of each type of information static and personalized are provided. The grouping of information for the first participant becomes a first data set that is stored at least temporarily on the computer means so that additional forms and bands can be generated. It follows that data created for the second, third, fourth, etc. participants would become the second, third and fourth data sets respectively. The data sets for each participant may be saved in a file for rendering and production at some later time or for a new event or activity that has been planned by the group leader, parent or guardian.

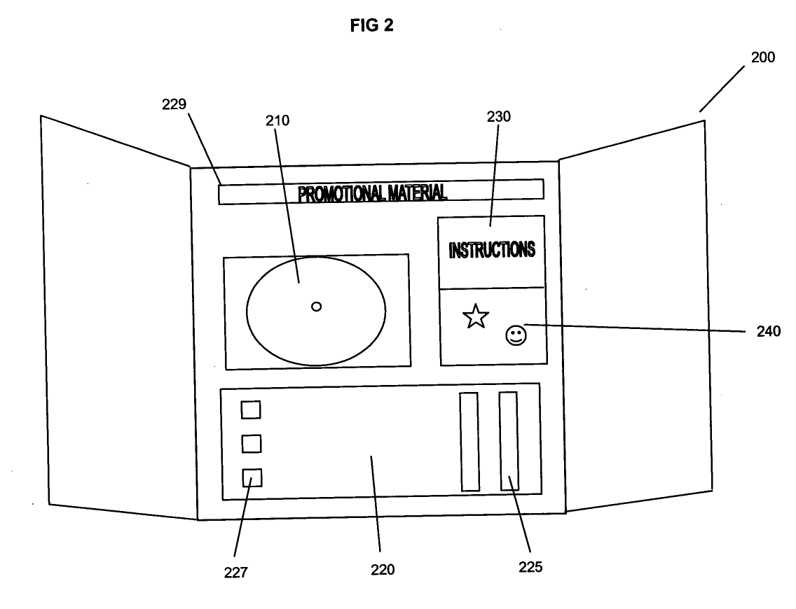

Turning now to FIG. 2 of the present invention a package containing the elements used in the system of the present invention is generally depicted by reference to numeral 200. The package or container 200, which is shown in an open condition so as to display the contents of the package, may be of any suitable construction including corrugated, plastic, shrink wrapped, and combinations of these.

The package 200 is provided with computer readable software 210, which in the present FIGURE is a compact disc (“CD”), such as one that may be found in a jewel case, sleeve or other device used to carry and protect the CD in which computer readable instructions have been provided. Upgrades for the software may be subsequently obtained over a global communication network, such as may be required for printing a different type of wristband or business form or to add additional graphics or the like to the wristband or form.

The package 200 also contains a stack of supply of business forms 220 which have a number of integral wristbands 225. The wristbands 225 may be provided one on a sheet or multiple bands may be provided on each sheet. The sheets may be of single thickness in which the bands are die cut and then punched out or the bands may be formed from a pressure sensitive laminate so as to enable the ready laminating or sealing of the bands through the use of exposed release and adhesive areas as will be readily understood by those with skill in the labels art.

The business forms 220 may also contain a number of removable labels 227 which may be decorative labels such that the participants may further personalize their bands or may be coupons that could be used as part of an attraction such as in obtaining discounts on meals, transportation and the like.

The package 200 of FIG. 2 is also provided with human readable instructions 230 which inform the purchaser and/or user of the package 200 how to install the software 210, feed the business forms 220 and use the wristbands 225 and labels 227. The human readable instructions may also include decorative labels 240 or other coupons that can be used in connection with the attraction or activity.

FIG. 2 also provides that the package 200 may include other promotional materials 229. Such materials can be printed, or may be additional software that can be utilized to review the promotions being offered. Alternatively, the promotional materials 229 may be pre-recorded cassettes, digital video discs, and the like so as to present the purchaser of the package with a preview of a predetermined destination that the group or family may be attending.

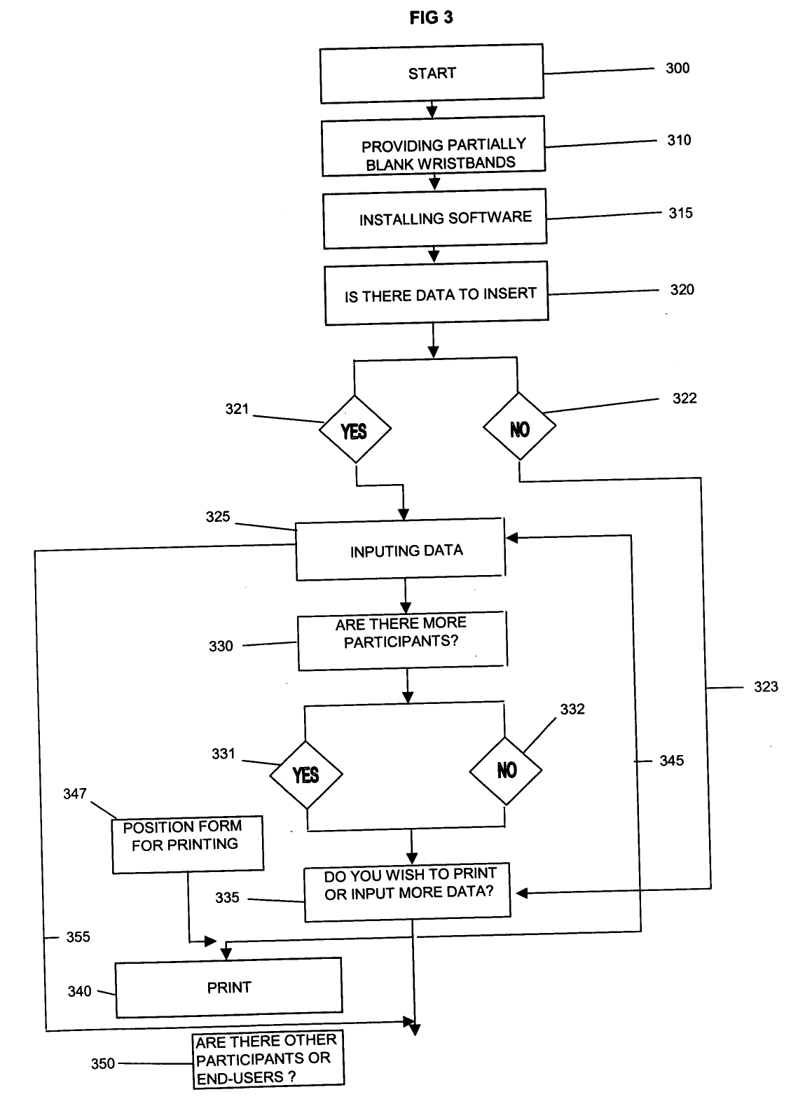

Attention is now directed to FIG. 3 of the present invention in which an exemplary method is illustrated through the use of a flow block diagram. Once the purchase of the package 200 provided in FIG. 2 has been made, the user starts the system at step 300 such as by opening the package and reading the human readable instructions and laying out the various pieces provided in the package. As described previously, the package is provided with a series of business or carrier forms containing one or more removable wristbands 310. The user or purchaser would then unwrap the forms if they are provided with a protective wrapping such as a shrink wrap or the like.

Next, and still referring to FIG. 3, the software is removed from the package and installed on a computer at step 315. The software can be fully encoded with the relevant instructions that are necessary to render and produce the wristband forms, or alternatively, the software can provide the user with access to a web site so that the user can then download the necessary instructions in order to complete the production of the wristbands.

After the software has been installed or downloaded at step 315, the software then presents the user with a query at step 320, such as might be displayed on a computer monitor. As depicted in FIG. 3 this query is “is there any data to insert.” The user can then answer the initial query with either “yes” or “no”, 321 and 322, respectively. If the user answers “no”, and just wants to print out wristbands from the form, the system diverts via communication means or route 323 from the remainder of the steps and simply renders a form, potentially with only static or fixed information such as the locations and dates of preprogrammed or predetermined activity.

In this situation, the user may have purchased the identification package directly from the attraction and the system would imprint static information, graphics and the like directly on the wristbands, in effect creating souvenirs for the family members to enjoy both prior to and subsequent to their visit to the attraction.

Where the user answers “yes” to the initial query, the user is then prompted to input data at step 325. The system will generate multiple prompts requiring the user to insert information that is unique to each participant in the activity or event. Such prompts may include name, address, physical description, phone numbers, contact information, dietary requirements and such other information that may be of use in attending the activity or event or in identifying or recognizing the individual as being part of a group or family.

After the first data set is created by inputting data relating to a first participant at step 325, the system will again query the user at step 330 to determine if there are additional participants to add and to create wristband for. The user may then again reply “yes” or “no”, 331 and 332 respectively. If the user has responded “no” then the user is given the opportunity to print or input some other data at step 345. The user then makes a selection to proceed to the print operation at step 340 or to return and be routed back 335 to the inputting sequence initiated at step 325.

Alternatively, if the user has responded in the affirmative or “yes” the user is presented with the same options at step 335 to either print or be rerouted back to the input sequence at 325. For example, rather than continue to create additional bands, the user may wish to print out the first band to see how it looks or to provide it to an anxious participant in the activity or event.

It should be understood where a user responds “no” at step 332 and is rerouted to the input sequence 325, the system will provide a different set of prompts such as asking for details relating to the activity and whether options may have been purchased or if there are decorative features to be added to the band prior to the band being printed. If the user has selected “yes” then upon being taken back to the input step 325, the user is then presented with participant two screen and is then asked to input similar to that input for the first participant. The user may also opt to personalize the first band or to add other features as described herein.

After the step of printing 340, the user is asked whether there are additional participants of if the system should now end at step 350. If the user responds “yes” then the user is routed back 355 to the input sequence 325 where the system asks for additional participant information or alternatively allows the user to select other personalized features for the band and form that is being created. An additional step that may occur is the positioning of the form at step 347 so that the form can be printed in a predetermined fashion so as to capture the information in the pre-selected areas of the wristband. It should be understood that in addition to indicia supplied by the system, the user or recipient may also add hand written information to the band.

FIG. 3A provides for a continuation of the flow diagram that is presented in FIG. 3. Once the wristband has been printed at step 340, the wristband, if prepared from a pressure sensitive laminate may be sealed at step 357. Sealing for example refers to the folding over of one portion of the wristband on to another with adhesive being used to hold the band in a laminated or sealed configuration.

The wristband is next removed from the form which serves as the carrier for the band through the printing step 340 and is placed on the wrist or other appendage of the participant at step 360. Placement of the band at step 360 generally will occur prior to the beginning of the event or activity that the group or family members are to participate in, such as prior to leaving home or the hotel room.

With the conclusion of the event or activity and the group or family member safely back to the point of origin, the band may be removed from the participant at step 370 and the process ends at 380.

The software and system of the present invention are intended to be reusable such that if the family or group is to participate in another event, the data sets that were created for each of the previous event's participants can now be retrieved, updated and provided there is a stock of available blank forms, a new set of forms with wrist bands can be produced in accordance with the exemplary method and system described herein. This may be particularly advantageous for a family or non-profit group in that the system is readily adaptable to subsequent uses thereby permitting the users to participate in other events or activities.

One of the most important things with respect to new innovations is the need to effectively market and communicate the new system to potential customers and end users of the system. Such marketing typically includes the creation of marketing collateral associated with the features of the present method and system and its benefits and uses. These products produced by the system and in accordance with the method of the present invention are sold in connection with that marketing collateral and then distributing the packaged system to potential end users and customers or transferring the technology to others for incorporation in their respective products. Potential customers can include distributors of such products as well as office supply stores, retail and warehouse outlets, schools, universities, groups, families and the like.

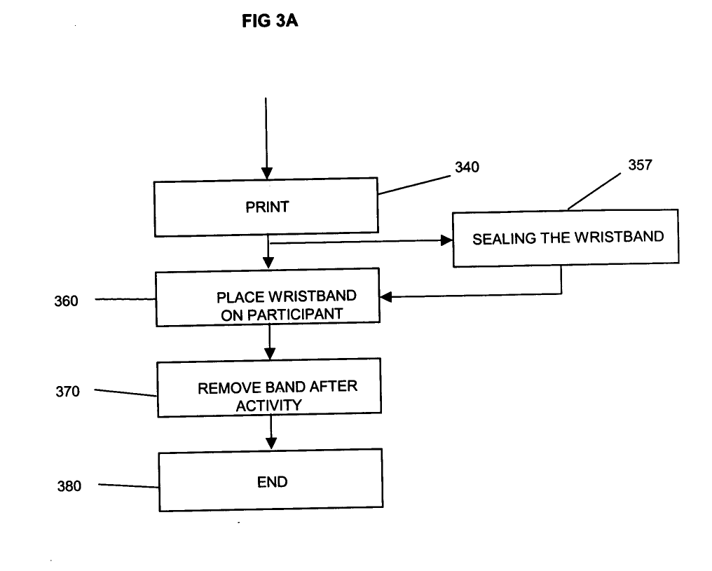

Reference is now directed to FIG. 4 of the present invention in which a block diagram is provided to illustrate an exemplary marketing method of the present invention. Initially, a package is prepared at step 400. The package, which is depicted in FIG. 2 contains a number of items, including but not limited to computer readable instructions, or software, a series or group of at least partially blank forms, human readable instructions to facilitate use of the system by a user or purchaser of the system, and possibly promotional materials and marketing collateral that may be used to entice the purchaser to use other products or services which may or may not be related to the particular applications or activities for which the system has been purchased.

Once the package has been prepared at step 400, promotional marketing materials may be inserted at step 410 depending upon the payment of advertising or slotting fees that an advertiser may pay or if a resort or attraction is sponsoring the package, then the resort or attraction may include their own information within the package.

Next, marketing collateral is developed at step 420 to promote the sale and use of the package. Such collateral may relay statistics of the number of lost or missing children each year and the need to provide an adequate means or manner to effectively identify and enable the recognition of children or participants in an event.

Finally, the package is distributed at step 430 to potential outlets, distributors, attractions or resort locations and the like for possible purchase or acquisition by end users.

Marketing collateral as used herein includes the use of scripted or prepared material that are distributed through audio and visual communication mediums, over a global communication network, through printed mediums such as newspapers, trade publications, magazines, fliers, handouts and the like.

In addition, marketing collateral as it relates to promotional offerings or consumer products and services could include items such as replacement toner or ink cartridges, other office supplies or stationery products, discounts off vacation packages, meals, transportation activities as well as any other sort of commercial product or service that may purchase space in the package of the present invention.

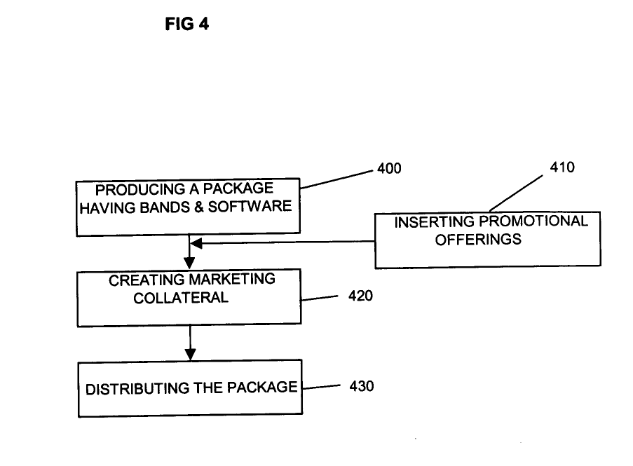

Turning now to FIG. 5 a representation of a wristband suitable for use in connection with the present invention and method related thereto is provided and generally depicted by reference to numeral 450. The wristband 450 has been removed from the business form or carrier (not shown) and desirably would be constructed form a material that is difficult to break, such as TYVEK®, polystyrene or polyethylene based materials and the like.

The wristband 450 of FIG. 5 is provided with a score line or line of weakness 453 which extends generally medially of the wristband so that the band may be folded upon itself to create a self sealing or laminated wristband that is more difficult to break from the appendage of the participant to which it has been applied.

As is also provided in FIG. 5, the wristband 450 is illustrated has having personalized information 460, here name, physical description, number and static information 462 such as the name of the attraction or event. In addition, the wristband 450 is also shown with a label or design that has been selected by the user or participant to further personalize the wristband to make it more appealing to the wearer or to indicate some other feature such as a club membership, sign or the like.

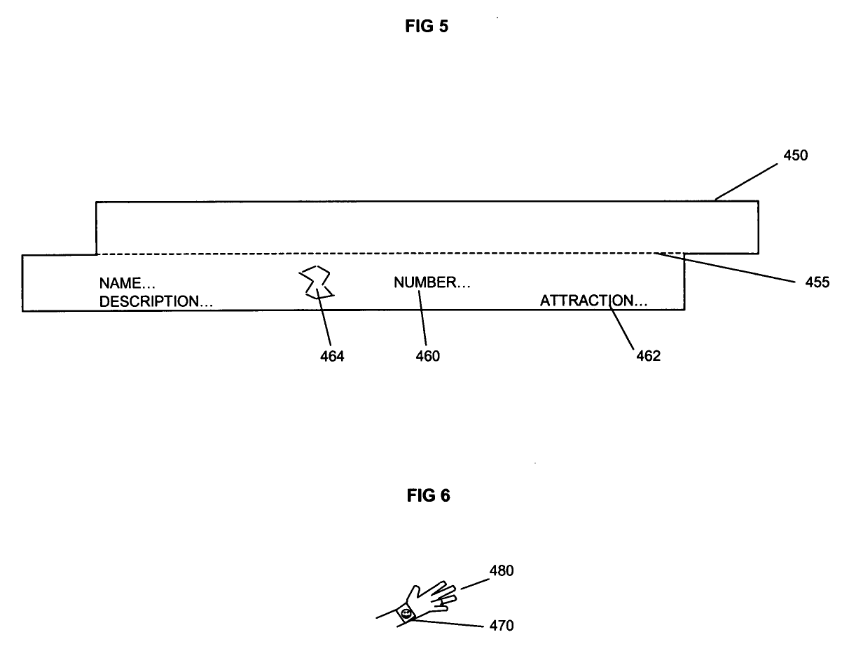

Turning now to FIG. 6, a wristband 470 created in connection with the system and method of the present invention has been applied to the wrist 480 of a hand, such as the hand of child or other participant in the selected activity or event for which the user created the wristband.

It will thus be seen according to the present invention a highly advantageous automated system and method for providing a personal identification package or kit for use by families or small groups has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A system for providing recognition elements to a small group or family, comprising;
a number of prepackaged business forms each with at least one detachable printable identification bands, each of the bands sized and configured to fit around an appendage;
readable software to enable the rendering of information to at least one of said bands contained within said package;
a computer means for reading said readable software;
an input means for inputting information into said computer means based on inquiries received from said software;
a connection means for connecting said computer means to a printer; and
said printer for imaging static and distinct indicia on each of said bands and said business forms for each member of a group or family.

2. A system as recited in claim 1, wherein said connection means includes a global communication network.

3. A system as recited in claim 1, wherein said computer means and said printer are located at locations remote from one another.

4. A system as recited in claim 1, wherein said computer means and said printer are located at a single location.

5. A system as recited in claim 1, wherein said communication means includes a local area network.

6. A system as recited in claim 1, wherein said software is provided on a compact disc.

7. A system as recited in claim 1, wherein said input means is a keyboard.

8. A personal identification package for a group or family, comprising;
a group of at least partially blank business forms with each form having a wristband and said business forms contained within a package;
a set of computer readable instructions for producing data on said partially blank business forms and wristbands;
a set of human readable instructions for using said computer readable instructions and said business forms and wristbands; and
a container for containing said partially blank business forms and wristbands, said computer readable instructions and said human readable instructions.

9. A personal identification package as recited in claim 8, wherein said package includes printed marketing materials relating to possible applications for said identification package.

10. A personal identification package as recited in claim 8, wherein said package includes printed promotional offers to consumer products or services.

11. A personal identification package as recited in claim 8, wherein said package further includes a series of removable, decorative labels for use in personalizing at least one of said wristbands.

12. A personal identification package as recited in claim 8, wherein said computer readable instructions are provided on a compact disc.

13. A method of using a personal identification system for a small group or family, comprising the steps of;
providing a series of at least partially blank business forms with each business form having at least one wristbands;
installing computer readable software containing instructions relating to use of said wristbands;
inputting information into a data field in response to queries received from said software for a each participant in a group or family activity;
determining whether additional participants are available for said group or family activity;
selecting whether to print said first data field onto at least a first business form and wristband or continuing with inputting data relating to additional participants; and
printing said business form and wristband for each member of said group or family with said data set.

14. A method as recited in claim 13, wherein each of said wristbands created through the method is provided with personalized and fixed information.

15. A method as recited in claim 14, wherein said fixed information is selected from a group including family information, group data, dates of an activity, name of an activity, place of an activity and combinations thereof.

16. A method as recited in claim 14, wherein said personalized information is selected from a group including physical descriptions of participants, birth dates, name and addresses, phone numbers, contact information and combinations thereof.

17. A method as recited in claim 14, including an additional step of positioning at least one wristband in a printer prior to the step of printing said at least one wristband.

18. A method as recited in claim 14, including an additional step of placing said at least one wristband on a participant for the activity after the step of printing said at least one wristband.

19. A method as recited in claim 14, including an additional step of removing said at least one wristband from a participant after the step of placing.

20. A method as recited in claim 14, including an additional step of folding over one portion of said wristband on to another to create a laminated wristband after the step of printing said at least one wristband.

21. A method of marketing a personal identification package to small groups and families for group activities, comprising the steps of;
producing a package, said package containing a number of imprintable business forms with each business form having an identification band and computer readable software;
creating marketing collateral targeted at small groups or families; and
distributing said package in response to requests from small groups or families.

22. A method of marketing as recited in claim 21, including a further step of inserting printed promotional offerings in the package after the step of producing the package.
